(19) United States
(12) Patent Application Publication
(10) Pub. No.: US 2018/0223904 A1
(43) Pub. Date: Aug. 9, 2018

(54) Angular contact ball bearing

(71) Applicant: Schaeffler Technologies AG & Co. KG, Herzogenaurach (DE)

(72) Inventor: Gerhard Nagengast, Heroldsbach (DE)

(73) Assignee: Schaeffler Technologies AG & Co. KG, Herzogenaurach (DE)

(21) Appl. No.: 15/747,929

(22) PCT Filed: Aug. 18, 2016
(86) PCT No.: PCT/DE2016/200385

§ 371 Date: Jan. 26, 2018

(30) Foreign Application Priority Data
Aug. 19, 2015 (DE) 10 2015 215 834.9

(51) Int. Cl. F16C 33/38; F16C 19/16; F16C 19/18

(52) U.S. Cl. CPC F16C 33/3806; F16C 19/163; F16C 33/3856; F16C 33/385; F16C 19/184

(57) ABSTRACT

Angular contact ball bearings are disclosed. In one example, the angular contact ball bearing may include an inner ring having an inner ring raceway and an outer ring having an outer ring raceway. A plurality of balls may roll on the inner and outer raceways. A cage may guide the plurality of balls in a plurality of closed pockets, wherein each ball is accommodated in one of the closed pockets. The bearing may include a plurality of projections, wherein each projection extends radially toward the raceway of the outer ring between every two adjacent, closed pockets. The cage may be guided on the outer ring raceway by the projections.

### CROSS-REFERENCE TO RELATED APPLICATIONS

This application is the U.S. National Phase of PCT Appln. No. PCT/DE2016/200385 filed Aug. 18, 2016, which claims priority to DE 102015215834.9 filed Aug. 19, 2015, the entire disclosures of which are incorporated by reference herein.

### TECHNICAL FIELD

The disclosure relates to an angular contact ball bearing comprising an inner ring having an inner ring raceway, an outer ring having an outer ring raceway, and a plurality of balls that roll on both raceways and are guided in a cage, wherein each ball is accommodated in a pocket of the cage.

### BACKGROUND

Angular contact bearings of this kind are used, for example, in machine tools, e.g. in rotary tables, dividing attachments, spindle bearings or similar applications, in which high rigidity and high operating speeds are important. The angular contact ball bearing is embodied as a double-row angular contact ball bearing, for example, or is built up from two single-row angular contact ball bearing halves set against one another. The rolling elements are cage-guided, i.e. the individual balls are accommodated in corresponding pockets of the cage. In this case, use is usually made of prong-type cages, which have open pockets into which the balls can be snapped during fitting.

The cage is normally guided on a flange of the inner or outer ring or on the rolling elements themselves. In the case of flange guidance, additional machining of the contact surfaces on the flange is required. Moreover, there must be a corresponding installation space to allow external guidance on one of the flanges. However, this is not always available in the case of a corresponding bearing design. In the case of guidance on the rolling elements, a correspondingly complex cage design with corresponding rolling element holders in cage pockets of the inherently flexible and unstable prong-type cages has to be provided.

### SUMMARY

One problem underlying the disclosure is therefore that of specifying an angular contact ball bearing of simple construction.

To solve this problem in an angular contact ball bearing of the type stated at the outset, the disclosure envisages that a projection that projects radially toward the outer ring raceway is provided between every two adjacent, closed pockets, wherein the cage is guided on the outer ring raceway by the plurality of projections.

In the angular contact ball bearing according to the disclosure, guidance of the cage is provided on the outer ring raceway to replace separate flange or rolling-bearing guidance. That is to say that the already existing outer ring raceway, which has already been machined for rolling element guidance, is used for cage guidance. The hitherto required machining operations on the flanges are thus eliminated. Moreover, a stable window-type cage with closed pockets, which is guided on the outer ring raceway, is provided instead of the unstable prong-type cage that was previously provided.

In order to achieve the guidance on the outer ring raceway, a plurality of projections, which project radially toward the outer ring raceway and via which the cage is supported on the outer ring raceway, is provided on the cage. It is conceivable to provide a respective projection between all the pairs of pockets but it would also be conceivable to form a corresponding projection between only every second or third pair of pockets, depending on the size of the ring. As described, this projection projects radially toward the outer ring raceway and supports the ring on the latter. Thus, it is only in this inherently well lubricated region that cage guidance takes place and the set of rolling elements is relieved of this task since it no longer contributes to cage guidance.

By virtue of the stable embodiment of the cage as a window-type cage, there is no risk of cage deformations of the kind which occur during operation of the bearing with previously used prong-type cages, wherein these deformations lead to in some cases considerable friction peaks, which have to be accommodated by the set of rolling elements. Instead, a stable cage is provided, which, in conjunction with guidance on the outer ring raceway, leads to better operating parameters of the bearing. This stable window-type cage leads to a reduction in noise by virtue of its low tendency for deformation, and an increase in speed is also possible, this resulting not least also from the guidance of this stable window-type cage on the outer ring raceway, which is supplied with lubricant.

The balls themselves can move freely within the pocket clearance and are not subject to any constraining forces due to cage guidance. Moreover, there is centering for the cage since the balls run in the pockets and, in turn, roll on the outer ring raceway, with the result that there is no offset between the cage guidance and the raceway. The cage pockets can be embodied with or without rolling element holders which act in the direction of the inner or the outer ring.

As shown in the examples, the cage according to the disclosure can be used both in single-row and in multi-row angular contact ball bearings, wherein the advantages according to the disclosure are achieved irrespective of the type of bearing.

The cage itself preferably has an encircling web, situated radially on the outside, which is interrupted by the pockets, wherein the projections are formed by the web portions remaining between the pockets. This encircling web, which projects over only a relatively narrow extent, enables the pockets to be formed in a simple manner, it being possible, for example, for the pockets to be formed by simple radially or obliquely extending holes. The web portions remaining between the pockets form the projections, which can also be referred to as contact bosses.

In the region forming the projections, the web itself should have an external shape which arches radially outward, which is therefore basically matched to the geometry of the outer ring raceway, giving surface-type support. Since the cage is supported on the outer ring raceway, which is well supplied with lubricant, there is thus excellent and extremely low-friction cage guidance.

According to the disclosure, the web itself can be provided on an axially extending outer ring portion, which is adjoined by a cage portion extending obliquely thereto, which cage portion is adjoined by an axially extending inner ring portion situated adjacent to the inner ring. Thus, when viewed in cross section, the cage has approximately a Z shape. In this form, it can readily be produced in a simple manner by corresponding production or machining methods since it does not have any complex undercuts or other guiding or holding geometries. By virtue of its simple and inherently stable geometry, the cage can be produced from virtually any known cage materials. Production from metals such as steel, brass or aluminum is conceivable, in which case the cage is then preferably produced by machining. However, formation from a hard material, e.g. ceramic, is likewise conceivable in combination with production by machining. Even manufacture from plastic and thus manufacture in corresponding large numbers by production of the cage in a plastics molding process is conceivable. The choice of material ultimately depends on the intended use of the angular contact ball bearing.

The Z shape allows a very narrow structural shape of the cage, which, in turn, allows correspondingly narrow structural shapes of the bearing and/or the use of additional sealing elements in the existing narrow installation space.

The web itself is expediently provided in the region of the inner end of the outer ring portion, and it is therefore necessarily positioned in the region of the outer ring raceway or the portion in which the balls also roll.

The maximum outside diameter of the cage in the region of the projections should be somewhat less than the inside diameter of the outer ring raceway in the region opposite the projections. That is to say that there is a slight clearance between the cage and the outer ring, wherein this clearance varies in the range of a few tenths of a millimeter.

As already described, the pockets themselves can be formed by holes extending obliquely or radially in a straight line. If there is sufficient axial space available, the pockets can be formed by radial holes. In the case of a reduced cage width and restricted space conditions, an oblique hole is preferred.

The angular contact ball bearing itself is preferably a double-row ball bearing, wherein the inner ring and the outer ring, of which one is in two parts, each have two raceways, wherein the balls guided in the respective raceway pairs are each guided in a cage, which cages are of identical design and are arranged in a mirror-image fashion relative to one another. As an alternative, the cage designed in accordance with the disclosure can of course also be used with a single-row angular contact ball bearing. The advantages according to the disclosure are achieved in all types of bearings, irrespective of the number of rows.

Overall, the guidance of the stable window-type cage by corresponding projections or contact bosses on the already machined outer ring raceway in the angular contact ball bearing according to the disclosure makes it possible to relieve the load on the set of rolling elements since this is not involved in cage guidance. Moreover, there are no machining steps for lateral flanges, which are likewise not involved in cage guidance, and it is also possible to achieve a corresponding improvement in the operating parameters of the angular contact ball bearing, in particular an increase in speed.

### BRIEF DESCRIPTION OF THE DRAWINGS

Further advantages and details will become apparent from the illustrative embodiments described below and from the drawings, in which:

FIG. 1 shows a section through a double-row angular contact ball bearing according to an embodiment of the disclosure, wherein the section plane is in the region of the projections on the cage,

FIG. 2 shows a section through the double-row angular contact ball bearing from FIG. 1, wherein the section plane is in the region of the pockets in the cage,

FIG. 3 shows a perspective view of one of the cages from FIG. 1,

FIG. 4 shows a partial view, in perspective, of the cage from FIG. 3,

FIG. 5 shows a lateral partial view of the two cages of the angular contact ball bearing from FIG. 1,

FIG. 6 shows a partial view, in perspective, of the angular contact ball bearing from FIG. 1, wherein only one cage is filled with balls,

FIG. 7 shows a diagrammatic representation, in section, of part of a single-row angular contact ball bearing with a straight-bore pocket,

FIG. 8 shows a diagrammatic representation, corresponding to FIG. 7, with an obliquely bored pocket, resulting in a space gain, e.g. for an additional sealing element,

FIG. 9 shows a diagrammatic representation of part of a single-row angular contact ball bearing with a straight-bore pocket, while the raceway groove is not fully recessed, and

FIG. 10 shows a diagrammatic representation corresponding to FIG. 9 with an obliquely bored pocket for a narrower construction.

### DETAILED DESCRIPTION

FIG. 1 shows a partial view of an angular contact ball bearing 1 according to the disclosure, which is here embodied as a double-row angular contact ball bearing. It comprises an outer ring 2 and an inner ring 3, which consists of two inner ring parts 3a, 3b. Two raceways are formed on the outer ring 2 and on the inner ring parts 3a, 3b, respectively, namely two outer ring raceways 4 and two inner ring raceways 5, on which corresponding balls 6 roll. The balls 6 themselves are each held in a cage 7, wherein the two cages, as FIG. 1 clearly shows, are of identical construction and are arranged in a mirror-image fashion relative to one another. For this purpose, the cage has a multiplicity of individual closed pockets 8, in each of which a ball 6 is accommodated and in which the ball 6 can move freely with slight play, with the result that the balls are not subject to any constraining forces due to cage guidance, which will be described below. Finally, two sealing elements 9 are provided on the outer ring 2, these being embodied by corresponding lamellar rings inserted into an encircling radial groove.

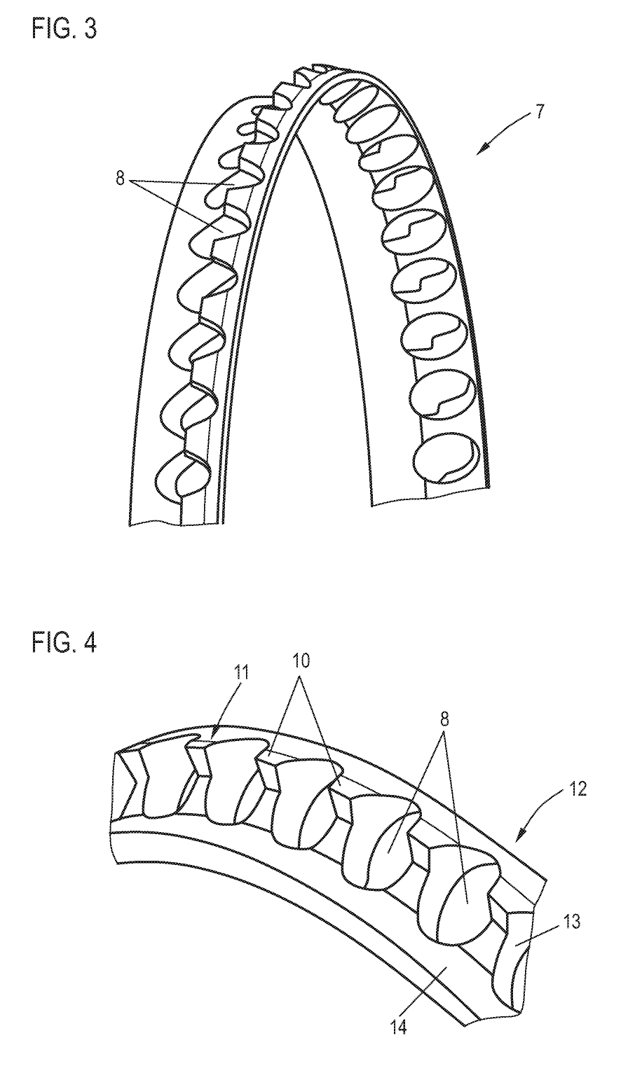

As FIG. 1 and, in particular, FIGS. 3 and 4 clearly show, the cage 7 has a plurality of projections 10, which project radially outward, i.e. project toward the outer ring raceway 4 and support the cage 7 on the outer ring raceway 4. Via these projections 10, which may also be referred to as contact bosses, the cage 7 is reliably guided in the region between the outer ring 2 and the inner ring 3. Since the balls 6 run on the outer ring and inner ring raceways 4, 5 and are centered thereby, the guidance of the cage 7 on the outer ring raceway 4 consequently also results in cage centering and the absence of an offset between the cage guidance and the raceway, leading to optimum running conditions and minimal friction. The cage diameter in the region of the projections 10 is slightly less than the diameter of the outer ring in the region of the outer ring raceway 8 or the region where the projections 10 engage thereon. This means that there is minimal play. Since the outer ring raceway is well lubricated, the cage guided thereon consequently participates in this lubrication, and therefore virtually frictionless cage guidance can be achieved.

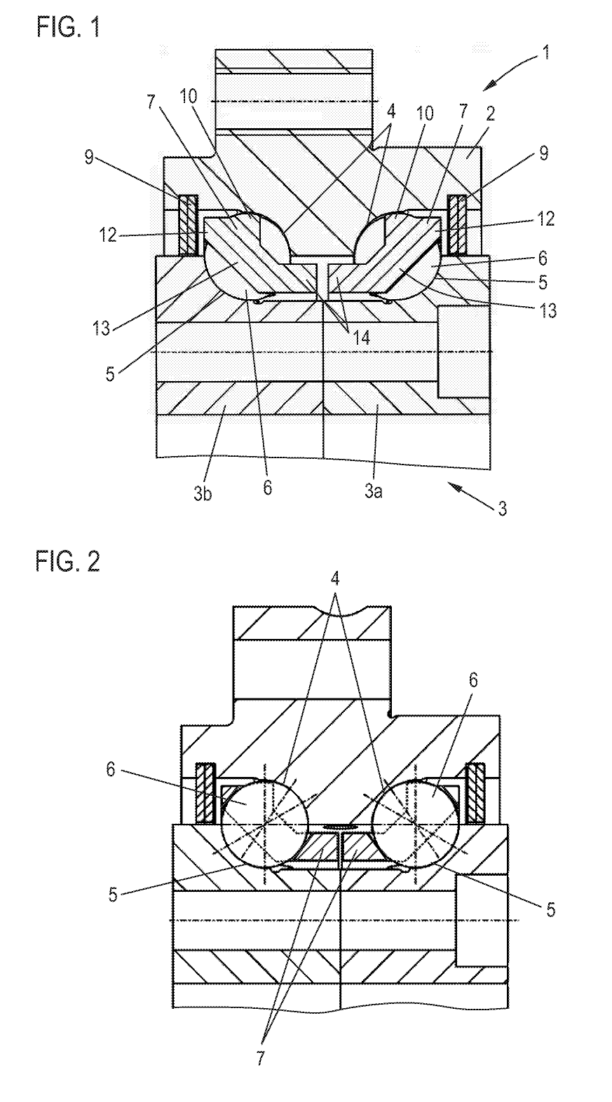

As FIGS. 2, 3 and 4 show, the projections 10 are each situated in the region of two adjacent pockets 8, i.e. they consequently do not obstruct either the pocket geometry or ball guidance in the pockets.

FIGS. 3 and 4 show a perspective view of the cage 7 shown on the right in FIG. 1, wherein the following statements apply equally to the left-hand cage 7, which is identical but arranged in a mirror-image fashion. The cage 7 is as it were “perforated” by the multiplicity of pockets 8, which are formed by simple holes, wherein a projection 10 is formed between every two pockets 8, see especially FIG. 4.

To form these projections, the cage 7 has an encircling web 11 situated radially on the outside, which is penetrated by the pockets (see especially FIG. 4). The introduction of these pocket holes necessarily leaves a web portion between the pockets 8 which forms the respective projection 10.

The cage itself has as it were a Z-shaped profile, wherein the web 11 is formed on an axially extending outer ring portion 12 (see also FIG. 1), which is adjoined by a cage portion 13 extending obliquely thereto, which cage portion is adjoined, in turn, by an axially extending inner ring portion 14 situated adjacent to the inner ring 3. There are therefore no complex geometries or undercuts provided, and this also simplifies the production of a cage of this kind. The Z-shaped profile furthermore allows cage structures which are of very narrow construction axially and, at the same time, stiff in terms of the shape thereof.

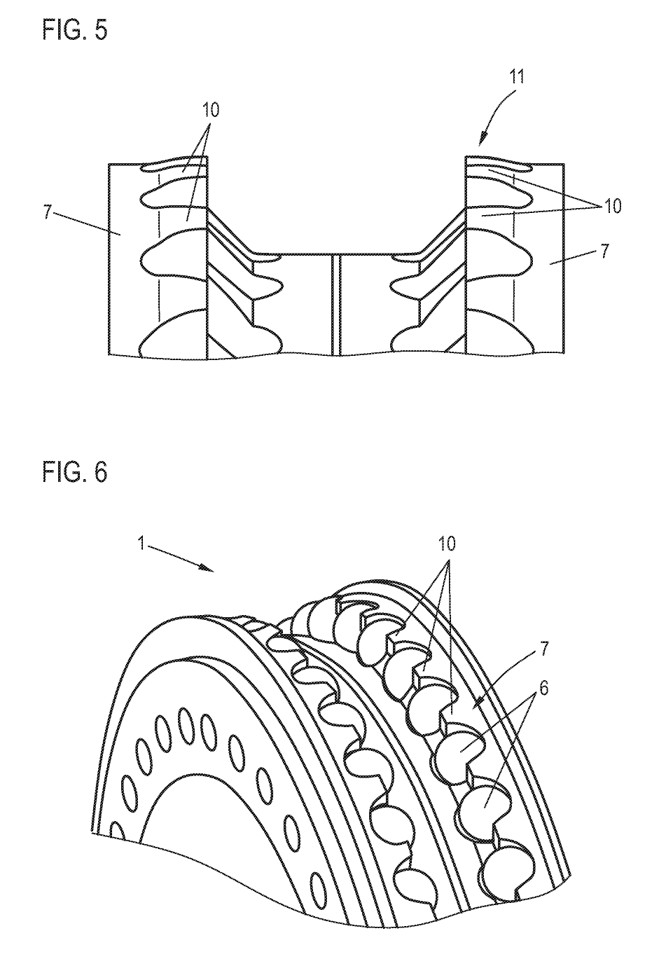

The geometry of the web 11 and hence of the projections 10 can be clearly seen from FIG. 5, where a partial view of the two cages 7 of the angular contact ball bearing from FIG. 1 is shown. As is apparent, the web 11 has an external shape which arches radially outward, with the result that the remaining projections are also slightly arched. Accordingly, the contour or geometry is matched to the geometry of the outer ring running surface, and therefore there is surface-type support, not point support.

FIG. 6 shows a perspective view of the angular contact ball bearing 1, wherein the outer ring is not shown here and also only one cage 7 is filled with balls 6. As can be seen, there is a web 11 between every two balls 6. Since the balls 6 run freely in the pockets 8, they are consequently not subject to any load or friction owing to the cage support provided by the projections 10, and they do not participate in cage guidance.

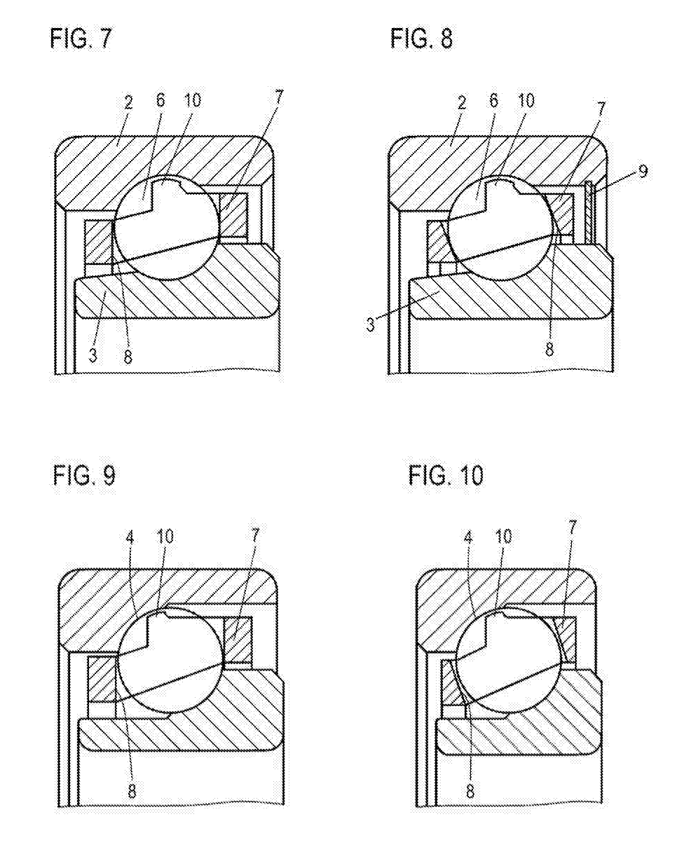

FIG. 7 shows a partial view of an angular contact ball bearing 1, having the outer ring 2 and the inner ring 3 for a single-row angular contact ball bearing. The balls 6 are, in turn, accommodated in a cage 7, which has corresponding projections 10. Here, the pockets 8 in the cage 7 are formed by a radially straight hole. The cage 7 is guided in the outer ring raceway 4 exclusively by the projections 10. No cage centering or cage contact diameter machining is required.

In contrast, FIG. 8 shows an example in which the pockets 8 of the cage 7 are formed by an oblique hole. This oblique hole is expedient particularly when there are restricted space conditions, i.e. when the width of the cage 7 cannot be correspondingly dimensioned. If a straight pocket hole were used here, the cage wall would be too thin in the pocket region. The narrow cage embodiment also allows the arrangement of sealing elements 9 in installation spaces which were previously too restricted.

While FIGS. 7 and 8 show embodiments of the angular contact ball bearing 1 with fully recessed raceway grooves having a reversal point at the base of the grooves, FIGS. 9 and 10 show embodiments in which the outer ring raceways 4 are not fully recessed, i.e. the respective outer ring raceway 4 merges into a step. As is apparent, a corresponding projection 10 can be formed on the respective cage 7 in this case too, the projection running on or being supported on the outer ring raceway 4, despite the fact that the latter is not fully recessed.

FIG. 9 shows an embodiment in which the pocket 8 is once again formed by a radially straight hole. In contrast, FIG. 10 shows an embodiment in which the pocket 8 is once again formed by an oblique hole owing to restricted space conditions. As can be seen, a significantly narrower construction is obtained here, when viewed axially.

The respective cage 7 itself is preferably composed of metal, e.g. steel, brass or aluminum. By virtue of the simple, inherently stable geometry, there is no problem in producing it by machining. Production by machining from a hard material such as ceramic or the like is also conceivable. Moreover, the cage 7 can be manufactured from plastic, e.g. in a simple injection-molding method, thus allowing correspondingly high numbers to be manufactured economically.

### LIST OF REFERENCE SIGNS

1 angular contact ball bearing
2 outer ring
3 inner ring
3a inner ring part
3b inner ring part
4 outer ring raceway
5 inner ring raceway
6 ball
7 cage
8 pocket
9 sealing element
10 projection
11 web
12 ring portion
13 cage portion
14 ring portion

1. An angular contact ball bearing comprising:
an inner ring having an inner ring raceway, an outer ring having an outer ring raceway, and a plurality of balls that roll on both raceways and are guided in a cage, wherein each ball is accommodated in a closed pocket of the cage; and
a projection that projects radially toward the outer ring raceway between every two adjacent, closed pockets, wherein the cage is guided on the outer ring raceway by the projections.

2. The angular contact ball bearing as claimed in claim 1, wherein the cage has an encircling web, situated radially on an outside, which is penetrated by the closed pockets, wherein the projections are formed by the web portions remaining between the closed pockets.

3. The angular contact ball bearing as claimed in claim 2, wherein the web has an external shape which arches radially outward in a region forming the projections.

4. The angular contact ball bearing as claimed in claim 3, wherein the web is provided on an axially extending outer ring portion, which is adjoined by a cage portion extending obliquely thereto, which cage portion is adjoined by an axially extending inner ring portion situated adjacent to the inner ring.

5. The angular contact ball bearing as claimed in claim 4, wherein the web is provided in a region of an inner end of an outer ring portion.

6. The angular contact ball bearing as claimed in claim 1, wherein a maximum outside diameter of the cage in a region of the projections is less than an inside diameter of the outer ring raceway in a region opposite the projections.

7. The angular contact ball bearing as claimed in claim 1, wherein the closed pockets are formed by holes extending obliquely or radially in a straight line.

8. The angular contact ball bearing as claimed in claim 1, wherein it is a double-row ball bearing, wherein the inner ring and the outer ring, of which one is in two parts, each have two raceways, wherein the balls guided in the respective raceway pairs are each guided in a cage, which cages are of identical design and are arranged in a mirror-image fashion relative to one another.

9. The angular contact ball bearing as claimed in claim 1, wherein the cage is composed of metal or plastic.

10. The angular contact ball bearing as claimed in claim 1, wherein the closed pockets are embodied with rolling element holders.

11. An angular contact ball bearing comprising:
an inner ring having an inner ring raceway;
an outer ring having an outer ring raceway;
a plurality of balls that roll on the inner and outer raceways
a cage that guides the plurality of balls in a plurality of closed pockets, wherein each ball is accommodated in one of the closed pockets; and
a plurality of projections, wherein each projection extends radially toward the raceway of the outer ring between every two adjacent, closed pockets;
wherein the cage is guided on the outer ring raceway by the projections.

12. The angular contact ball bearing as claimed in claim 11, wherein the cage has an encircling web, situated radially on an outside, which is penetrated by the closed pockets, wherein the projections are formed by web portions remaining between the closed pockets.

13. The angular contact ball bearing as claimed in claim 12, wherein the web has an external shape which arches radially outward in a region forming the projections.

14. The angular contact ball bearing as claimed in claim 13, wherein the web is provided on an axially extending outer ring portion, which is adjoined by a cage portion extending obliquely thereto, which cage portion is adjoined by an axially extending inner ring portion situated adjacent to the inner ring.

15. The angular contact ball bearing as claimed in claim 14, wherein the web is provided in a region of an inner end of an outer ring portion.

16. The angular contact ball bearing as claimed in claim 11, wherein a maximum outside diameter of the cage in a region of the projections is less than an inside diameter of the outer ring raceway in a region opposite the projections.

17. The angular contact ball bearing as claimed in claim 11, wherein the closed pockets are formed by holes extending obliquely or radially in a straight line.

18. The angular contact ball bearing as claimed in claim 11, wherein it is a double-row ball bearing, wherein the inner ring and the outer ring, of which one is in two parts, each have two raceways, wherein the balls guided in the respective raceway pairs are each guided in a cage, which cages are of identical design and are arranged in a mirror-image fashion relative to one another.

19. The angular contact ball bearing as claimed in claim 11, wherein the cage is composed of metal or plastic.

20. The angular contact ball bearing as claimed in claim 11, wherein the closed pockets are embodied without rolling element holders.
